(19) United States
(12) Patent Application Publication
(10) Pub. No.: US 2010/0020961 A1
(43) Pub. Date: Jan. 28, 2010

(54) ROUTING CALLERS TO AGENTS BASED ON TIME EFFECT DATA

(75) Inventor: S. James P. SPOTTISWOODE, Beverly Hills, CA (US)

Correspondence Address: MORRISON & FOERSTER LLP, 755 PAGE MILL RD, PALO ALTO, CA, 94304-1018, US

(73) Assignee: The Resource Group International LTD, Hamilton (BM)

(21) Appl. No.: 12/267,471

(22) Filed: Nov. 7, 2008

Related U.S. Application Data
(60) Provisional application No. 61/084,201, filed on Jul. 28, 2008.

(51) Int. Cl. H04M 3/00

(52) U.S. Cl. 379/265.12

(57) ABSTRACT

Systems and methods are disclosed for routing callers to agents in a contact center, along with an intelligent routing system. Exemplary methods include routing a caller from a set of callers to an agent from a set of agents based on a performance based routing and/or pattern matching algorithm(s) utilizing caller data associated with the caller and the agent data associated with the agent. For performance based routing, the performance or grading of agents may be associated with time data, e.g., a grading or ranking of agents based on time. Further, for pattern matching algorithms, one or both of the caller data and agent data may include or be associated with time effect data. Examples of time effect data include probable performance or output variables as a function of time of day, day of week, time of month, or time of year. Time effect data may also include the duration of the agent's employment.

### CROSS REFERENCE TO RELATED APPLICATIONS

This application claims benefit to U.S. provisional Patent Application Ser. No. 61/084,201, filed Jul. 28, 2008, which is incorporated herein by reference in its entirety for all purposes. This application is further related to U.S. patent application Ser. No. 12/021,251, filed Jan. 28, 2008, which is hereby incorporated by reference in its entirety.

### BACKGROUND

1. Field

The present invention relates generally to the field of routing phone calls and other telecommunications in a contact center system.

2. Related Art

The typical contact center consists of a number of human agents, with each assigned to a telecommunication device, such as a phone or a computer for conducting email or Internet chat sessions, that is connected to a central switch. Using these devices, the agents are generally used to provide sales, customer service, or technical support to the customers or prospective customers of a contact center or a contact center's clients.

Typically, a contact center or client will advertise to its customers, prospective customers, or other third parties a number of different contact numbers or addresses for a particular service, such as for billing questions or for technical support. The customers, prospective customers, or third parties seeking a particular service will then use this contact information, and the incoming caller will be routed at one or more routing points to a human agent at a contact center who can provide the appropriate service. Contact centers that respond to such incoming contacts are typically referred to as “inbound contact centers.”

Similarly, a contact center can make outgoing contacts to current or prospective customers or third parties. Such contacts may be made to encourage sales of a product, provide technical support or billing information, survey consumer preferences, or to assist in collecting debts. Contact centers that make such outgoing contacts are referred to as “outbound contact centers.”

In both inbound contact centers and outbound contact centers, the individuals (such as customers, prospective customers, survey participants, or other third parties) that interact with contact center agents using a telecommunication device are referred to in this application as a “caller.” The individuals acquired by the contact center to interact with callers are referred to in this application as an “agent.”

Conventionally, a contact center operation includes a switch system that connects callers to agents. In an inbound contact center, these switches route incoming callers to a particular agent in a contact center, or, if multiple contact centers are deployed, to a particular contact center for further routing. In an outbound contact center employing telephone devices, dialers are typically employed in addition to a switch system. The dialer is used to automatically dial a phone number from a list of phone numbers, and to determine whether a live caller has been reached from the phone number called (as opposed to obtaining no answer, a busy signal, an error message, or an answering machine). When the dialer obtains a live caller, the switch system routes the caller to a particular agent in the contact center.

Routing technologies have accordingly been developed to optimize the caller experience. For example, U.S. Pat. No. 7,236,584 describes a telephone system for equalizing caller waiting times across multiple telephone switches, regardless of the general variations in performance that may exist among those switches. Contact routing in an inbound contact center, however, is a process that is generally structured to connect callers to agents that have been idle for the longest period of time. In the case of an inbound caller where only one agent may be available, that agent is generally selected for the caller without further analysis. In another example, if there are eight agents at a contact center, and seven are occupied with contacts, the switch will generally route the inbound caller to the one agent that is available. If all eight agents are occupied with contacts, the switch will typically put the contact on hold and then route it to the next agent that becomes available. More generally, the contact center will set up a queue of incoming callers and preferentially route the longest-waiting callers to the agents that become available over time. Such a pattern of routing contacts to either the first available agent or the longest-waiting agent is referred to as “round-robin” contact routing. In round robin contact routing, eventual matches and connections between a caller and an agent are essentially random.

In an outbound contact center environment using telephone devices, the contact center or its agents are typically provided a “lead list” comprising a list of telephone numbers to be contacted to attempt some solicitation effort, such as attempting to sell a product or conduct a survey. The lead list can be a comprehensive list for all contact centers, one contact center, all agents, or a sub-list for a particular agent or group of agents (in any such case, the list is generally referred to in this application as a “lead list”). After receiving a lead list, a dialer or the agents themselves will typically call through the lead list in numerical order, obtain a live caller, and conduct the solicitation effort. In using this standard process, the eventual matches and connections between a caller and an agent are essentially random.

Some attempts have been made to improve upon these standard yet essentially random processes for connecting a caller to an agent. For example, U.S. Pat. No. 7,209,549 describes a telephone routing system wherein an incoming caller's language preference is collected and used to route their telephone call to a particular contact center or agent that can provide service in that language. In this manner, language preference is the primary driver of matching and connecting a caller to an agent, although once such a preference has been made, callers are almost always routed in “round-robin” fashion.

Other attempts have been made to alter the general round-robin system. For example, U.S. Pat. No. 7,231,032 describes a telephone system wherein the agents themselves each create personal routing rules for incoming callers, allowing each agent to customize the types of callers that are routed to them. These rules can include a list of particular callers the agent wants routed to them, such as callers that the agent has interacted with before. This system, however, is skewed towards the agent's preference and does not take into account the relative capabilities of the agents nor the individual characteristics of the callers and the agents themselves.

### BRIEF SUMMARY

Systems and methods of the present invention can be used to improve or optimize the routing of callers to agents in a contact center. According to one aspect, a method for operating a call routing center includes routing a caller from a set of callers to an agent from a set of agents based on a pattern matching algorithm utilizing agent data associated with the agent from the set of agents and caller data associated with the caller from the set of callers, wherein one or both of the agent data and the caller data includes or is associated with time data or information (referred to herein as “time effect data”). For instance, the agent data and caller data utilized by the pattern matching algorithm may include time effect data associated with performance, probable performance, or output variables as a function of one or more of time of day, day of week, time of month, time of year, and so on. The pattern matching algorithm may operate to compare caller data associated with each caller to agent data associated with each agent to determine an optimal matching of a caller to an agent, and further includes an analysis of time effect on the performance of agents or probable outcomes of the particular matching.

Time effect data can be collected and used within the systems and methods alone or in combination with other data, agent grades, and so on for matching callers to agents. Time effect data may refer to various times of the day, week, month, year, season, and so on. For instance, certain agents may perform well in the morning, but not in the afternoon. Further, certain agents may perform well with certain callers at certain times of the day or week, but not on other times or days. Additionally, certain callers may react to agents differently depending on the time, e.g., the chance of a sale occurring with a caller over 50 may be substantially greater before 5 pm than after 5 pm. Time effect data may also refer to the duration a particular agent has been employed. For instance, an agent who has only been employed for 2 days may not be as productive as an agent who has been employed for 2 months.

According to another aspect, apparatus is provided comprising logic for routing a caller from a set of callers to an agent from a set of agents based on a pattern matching algorithm utilizing agent data associated with the agent from the set of agents and caller data associated with the caller from the set of callers, wherein one or both of the agent data and the caller data is associated with time effect data.

Many of the techniques described here may be implemented in hardware, firmware, software, or combinations thereof. In one example, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices. Moreover, each program is preferably implemented in a high level procedural or object-oriented programming language to communicate with a computer system. However, the programs can be implemented in assembly or machine language, if desired. In any case, the language may be a compiled or interpreted language.

### BRIEF DESCRIPTION OF THE DRAWINGS

FIG. 1 is a diagram reflecting the general setup of a contact center operation.

FIG. 2 is a flowchart reflecting one embodiment of the invention involving a method for the operating an inbound contact center.

FIG. 3 is a flowchart reflecting one embodiment of the invention involving a method for the operating an inbound contact center with weighted optimal interactions.

FIG. 4 is a flowchart reflecting one embodiment of the invention reflecting a method of operating an outbound contact center.

FIG. 5 is a flowchart reflecting a more advanced embodiment of the present invention using agent data and caller data in an inbound contact center.

FIG. 6 is a flowchart reflecting a more advanced embodiment of the present invention using agent data and caller data in an outbound contact center.

FIG. 7 is a flowchart reflecting an embodiment of the present invention for selecting a caller from a pool of callers using agent data and caller data.

FIG. 8A is a flowchart reflecting an embodiment of the present invention for matching a caller to an agent using time effect data associated with one or both of the caller and agent.

FIG. 8B is a flowchart reflecting an embodiment of the present invention for matching a caller to an agent using time effect data associated with one or both of an agent of a set of agents and a caller of a set of callers.

FIG. 8C is a flowchart reflecting an embodiment of the present invention for matching a caller to an agent using time effect data associated with one or both of an agent of a set of agents and a caller of a set of callers.

FIG. 9 illustrates a typical computing system that may be employed to implement some or all processing functionality in certain embodiments of the invention.

### DETAILED DESCRIPTION OF THE INVENTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

According to one aspect of the present invention systems, methods, and displayed computer interfaces are provided for routing a caller from a set of callers to an agent from a set of agents based on performance of the set of agents and/or a pattern matching algorithm utilizing agent data, wherein one or both of the agent data and the caller data is associated with time effect data. Time effect data may include the effect of time on a desired performance or outcome variable and may include one or more of the following: a time of day, day of week, time of month, time of year, agent performance based on time, and the duration of the agent's employment. The pattern matching algorithm may operate to compare caller data associated with each caller to agent data associated with each agent. In one example, the order in which the caller is routed is not based on a queue order; for example, callers may either be pulled out of a conventional queue or pooled and routed based on performance routing and/or pattern matching algorithm(s).

It is noted that various techniques may be used to detect stationary or non-stationary time effects on one or more performance variables of a call routing center, and from which the exemplary methods and systems may exploit by preferentially matching callers to agents according to such detected time effects. Call center routing systems are generally complex and a range of techniques may be used to detect periodicity or other patterns in the data; exemplary techniques may include, but are not limited to, time series analysis methods, fast Fourier transform (FFT) algorithms, wavelet analysis methods, power spectrum analysis, autoregressive integrated moving average (ARIMA) methods, combinations thereof, and the like.

Additionally, it is noted that time effect data may include both stationary and non-stationary time effects. For instance, a stationary time effect may include a change in an output variable in which the frequency and oscillation is generally predictable by reference to the time of day, month, season, and so. In contrast, non-stationary time effects are generally characterized in that the effect shifts or oscillate unpredictably, e.g., the frequency or phase of the change is not fixed in time.

Initially, exemplary call routing systems and methods utilizing performance and/or pattern matching algorithms (either of which may be used within generated computer models for predicting the chances of desired outcomes) are described for routing callers to available agents. This description is followed by exemplary methods for routing callers to agents based on agent data and caller data associated with time effect data.

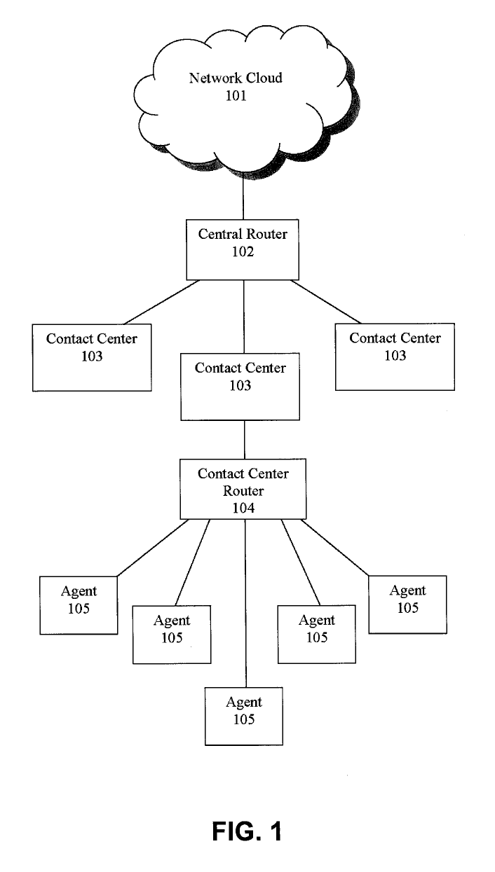

FIG. 1 is a diagram reflecting the general setup of a contact center operation 100. The network cloud 101 reflects a specific or regional telecommunications network designed to receive incoming callers or to support contacts made to outgoing callers. The network cloud 101 can comprise a single contact address, such as a telephone number or email address, or multiple contract addresses. The central router 102 reflects contact routing hardware and software designed to help route contacts among call centers 103. The central router 102 may not be needed where there is only a single contact center deployed. Where multiple contact centers are deployed, more routers may be needed to route contacts to another router for a specific contact center 103. At the contact center level 103, a contact center router 104 will route a contact to an agent 105 with an individual telephone or other telecommunications equipment 105. Typically, there are multiple agents 105 at a contact center 103, though there are certainly embodiments where only one agent 105 is at the contact center 103, in which case a contact center router 104 may prove to be unnecessary.

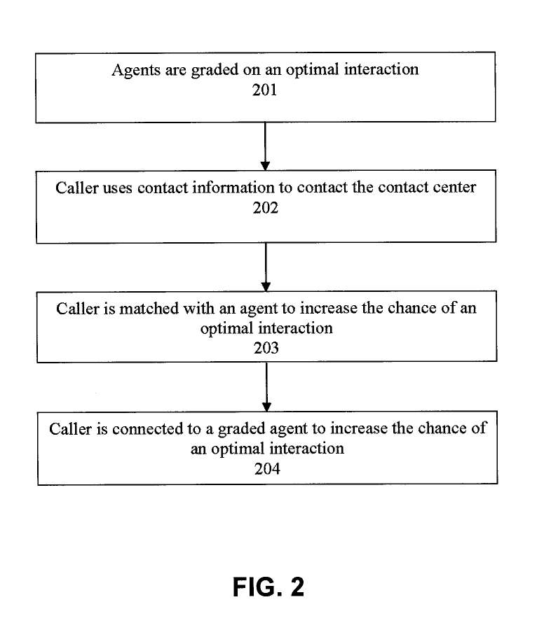

FIG. 2 is a flowchart of one embodiment of the invention involving a method for operating an inbound contact center, the method comprising grading two agents on an optimal interaction and matching a caller with at least one of the two graded agents to increase the chance of the optimal interaction. At the initial block 201, agents are graded on an optimal interaction, such as increasing revenue, decreasing costs, or increasing customer satisfaction. Grading is accomplished by collating the performance of a contact center agent over a period of time on their ability to achieve an optimal interaction, such as a period of at least 10 days. However, the period of time can be as short as the immediately prior contact to a period extending as long as the agent's first interaction with a caller. Moreover, the method of grading agent can be as simple as ranking each agent on a scale of 1 to N for a particular optimal interaction, with N being the total number of agents. The method of grading can also comprise determining the average contact handle time of each agent to grade the agents on cost, determining the total sales revenue or number of sales generated by each agent to grade the agents on sales, or conducting customer surveys at the end of contacts with callers to grade the agents on customer satisfaction. The grading of agents may further include or be associated with time data, e.g., the grading of a set of agents may vary or change based on the time of day, week, month, and so on. Accordingly, the grading or ranking of agents may be made time dependent. The foregoing, however, are only examples of how agents may be graded; many other methods may be used.

At block 202 a caller uses contact information, such as a telephone number or email address, to initiate a contact with the contact center. At block 203, the caller is matched with an agent or group of agents such that the chance of an optimal interaction is increased, as opposed to just using the round robin matching methods of the prior art. The matching can occur between a caller and all agents logged in at the contact center, all agents currently available for a contact at the contact center, or any mix or subgroup thereof. The matching rules can be set such that agents with a minimum grade are the only ones suitable for matching with a caller. The matching rules can also be set such that an available agent with the highest grade for an optimal interaction or mix thereof is matched with the caller. To provide for the case in which an agent may have become unavailable in the time elapsed from the time a contact was initiated to the time the switch was directed to connect the caller to a specific agent, instead of directing the switch to connect the caller to a single agent, the matching rules can define an ordering of agent suitability for a particular caller and match the caller to the highest-graded agent in that ordering. At block 204, the caller is then connected to a graded agent to increase the chance of an optimal interaction, and the contact interaction between the agent and the caller then occurs.

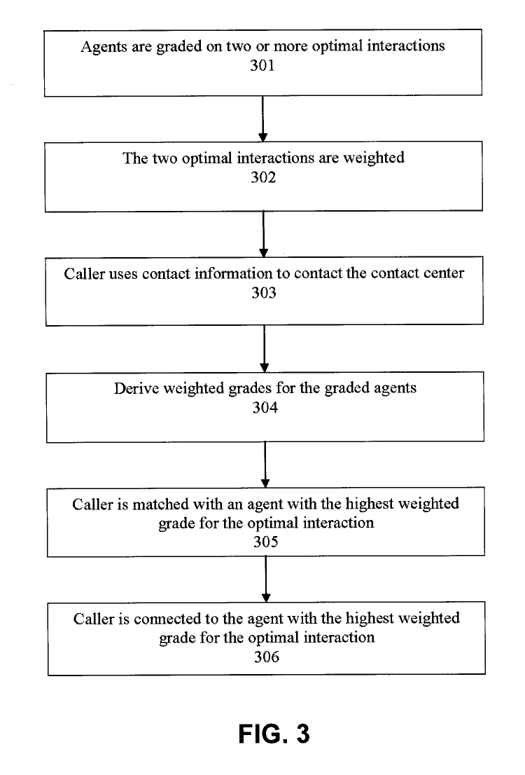

FIG. 3 is a flowchart of one embodiment of the invention involving a method for the operating an inbound contact center, the method comprising grading a group of at least two agents on two optimal interactions, weighting one optimal interaction against another optional interaction, and connecting the caller with one of the two graded agents to increase the chance of a more heavily-weighted optimal interaction. At block 301, agents are graded on two or more optimal interactions, such as increasing revenue, decreasing costs, or increasing customer satisfaction. At block 302, the optimal interactions are weighted against each other. The weighting can be as simple as assigning to each optimal interaction a percentage weight factor, with all such factors totaling to 100 percent. Any comparative weighting method can be used, however. The weightings placed on the various optimal interactions can take place in real-time in a manner controlled by the contact center, its clients, or in line with pre-determined rules. Optionally, the contact center or its clients may control the weighting over the internet or some another data transfer system. As an example, a client of the contact center could access the weightings currently in use over an internet browser and modify these remotely. Such a modification may be set to take immediate effect and, immediately after such a modification, subsequent caller routings occur in line with the newly establishing weightings. An instance of such an example may arise in a case where a contact center client decides that the most important strategic priority in their business at present is the maximization of revenues. In such a case, the client would remotely set the weightings to favor the selection of agents that would generate the greatest probability of a sale in a given contact. Subsequently the client may take the view that maximization of customer satisfaction is more important for their business. In this event, they can remotely set the weightings of the present invention such that callers are routed to agents most likely to maximize their level of satisfaction. Alternatively the change in weighting may be set to take effect at a subsequent time, for instance, commencing the following morning.

At block 303, a caller uses contact information, such as a telephone number or email address, to initiate a contact with the contact center. At block 304, the optimal interaction grades for the graded agents are used with the weights placed on those optimal interactions to derive weighted grades for those graded agents. At block 305, the caller is matched with an available agent with the highest weighted grade for the optimal interaction. At block 306, the caller is then connected to the agent with the highest weighted grade to increase the chance of the more-heavily weighted optimal interaction. This embodiment can also be modified such that the caller is connected to the agent with the highest-weighted mix of grades to increase the chance of the more-heavily weighted mix of optimal interactions. It will be appreciated that the steps outlined in the flowchart of FIG. 3 need not occur in that exact order.

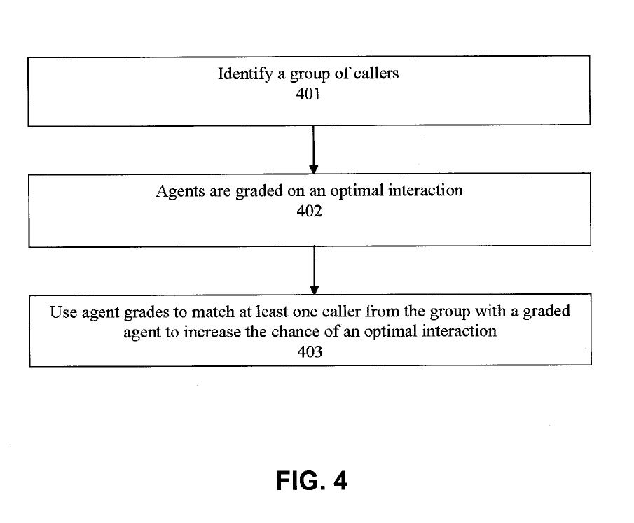

FIG. 4 is a flowchart of one embodiment of the invention reflecting a method of operating an outbound contact center, the method comprising, identifying a group of at least two callers, grading two agents on an optimal interaction; and matching at least one of the two graded agents with at least one caller from the group. At block 401, a group of at least two callers is identified. This is typically accomplished through the use of lead list that is provided to the contact center by the contact center's client. At block 402, a group of at least two agents are graded on an optimal interaction. At block 403, the agent grades are used to match one or more of the callers from the group with one or more of the graded agents to increase the chance of an optimal interaction. This matching can be embodied in the form of separate lead lists generated for one or more agents, which the agents can then use to conduct their solicitation efforts.

In an outbound contact center employing telephone devices, it is more common to have a dialer call through a lead list. Upon a dialer obtaining a live caller, the present invention can determine the available agents and their respective grades for the optimal interaction, match the live caller with one or more of the available agents to increase the chance of an optimal interaction, and connect the caller with one of those agents who can then conduct their solicitation effort. Preferably, the present invention will match the live caller with a group of agents, define an ordering of agent suitability for the caller, match the live caller to the highest-graded agent currently available in that ordering, and connect the caller to the highest-graded agent. In this manner, use of a dialer becomes more efficient in the present invention, as the dialer should be able to continuously call through a lead list and obtain live callers as quickly as possible, which the present invention can then match and connect to the highest graded agent currently available. It will be appreciated that the steps outlined in the flowchart of FIG. 4 need not occur in that exact order.

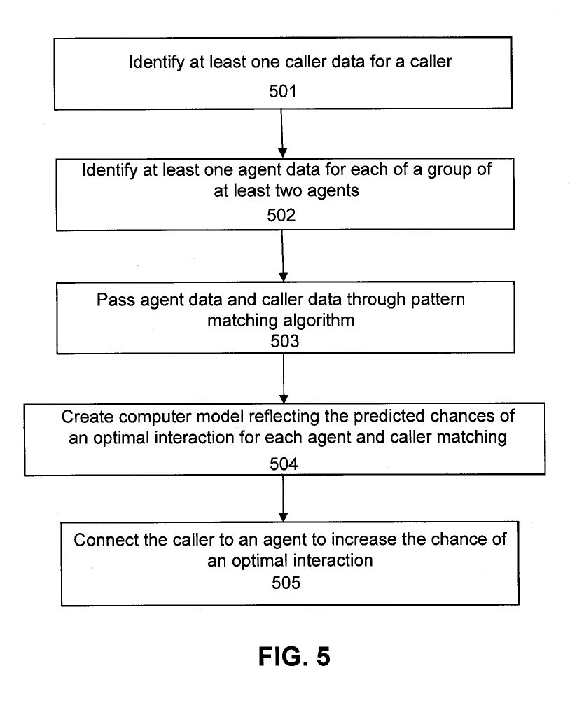

FIG. 5 is a flowchart reflecting a more advanced embodiment of the present invention that can be used to increase the chances of an optimal interaction by combining agent grades, agent demographic data, agent psychographic data, agent time effect data, and other business-relevant data about the agent (individually or collectively referred to in this application as “agent data”), along with demographic data, psychographic data, time effect data, and other business-relevant data about callers (individually or collectively referred to in this application as “caller data”). Agent and caller demographic data can comprise any of: gender, race, age, education, accent, income, nationality, ethnicity, area code, zip code, marital status, job status, and credit score. Agent and caller psychographic data can comprise any of introversion, sociability, desire for financial success, and film and television preferences. It will be appreciated that the steps outlined in the flowchart of FIG. 5 need not occur in that exact order.

Accordingly, an embodiment of a method for operating an inbound contact center comprises determining at least one caller data for a caller, determining at least one agent data for each of two agents, using the agent data and the caller data in a pattern matching algorithm, and matching the caller to one of the two agents to increase the chance of an optimal interaction. At block 501, at least one caller data (such as caller demographic data, psychographic data, time effect data, etc.) is determined. One way of accomplishing this is by retrieving this from available databases by using the caller's contact information as an index. Available databases include, but are not limited to, those that are publicly available, those that are commercially available, or those created by a contact center or a contact center client. In an outbound contact center environment, the caller's contact information is known beforehand. In an inbound contact center environment, the caller's contact information can be retrieved by examining the caller's CallerID information or by requesting this information of the caller at the outset of the contact, such as through entry of a caller account number or other caller-identifying information. Other business-relevant data such as historic purchase behavior, current level of satisfaction as a customer, or volunteered level of interest in a product may also be retrieved from available databases.

At block 502, at least one agent data (such as agent demographic data, psychographic data, time effect data, etc.) for each of two agents is determined. One method of determining agent demographic or psychographic data can involve surveying agents at the time of their employment or periodically throughout their employment. Such a survey process can be manual, such as through a paper or oral survey, or automated with the survey being conducted over a computer system, such as by deployment over a web-browser.

Though this advanced embodiment preferably uses agent grades, demographic, psychographic, and other business-relevant data, along with caller demographic, psychographic, and other business-relevant data, other embodiments of the present invention can eliminate one or more types or categories of caller or agent data to minimize the computing power or storage necessary to employ the present invention.

Once agent data and caller data have been collected, this data is passed to a computational system. The computational system then, in turn, uses this data in a pattern matching algorithm at block 503 to create a computer model that matches each agent with the caller and estimates the probable outcome of each matching along a number of optimal interactions, such as the generation of a sale, the duration of contact, or the likelihood of generating an interaction that a customer finds satisfying.

The pattern matching algorithm to be used in the present invention can comprise any correlation algorithm, such as a neural network algorithm or a genetic algorithm. To generally train or otherwise refine the algorithm, actual contact results (as measured for an optimal interaction) are compared against the actual agent and caller data for each contact that occurred. The pattern matching algorithm can then learn, or improve its learning of, how matching certain callers with certain agents will change the chance of an optimal interaction. In this manner, the pattern matching algorithm can then be used to predict the chance of an optimal interaction in the context of matching a caller with a particular set of caller data, with an agent of a particular set of agent data. Preferably, the pattern matching algorithm is periodically refined as more actual data on caller interactions becomes available to it, such as periodically training the algorithm every night after a contact center has finished operating for the day.

At block 504, the pattern matching algorithm is used to create a computer model reflecting the predicted chances of an optimal interaction for each agent and caller matching. Preferably, the computer model will comprise the predicted chances for a set of optimal interactions for every agent that is logged in to the contact center as matched against every available caller. Alternatively, the computer model can comprise subsets of these, or sets containing the aforementioned sets. For example, instead of matching every agent logged into the contact center with every available caller, the present invention can match every available agent with every available caller, or even a narrower subset of agents or callers. Likewise, the present invention can match every agent that ever worked on a particular campaign—whether available or logged in or not—with every available caller. Similarly, the computer model can comprise predicted chances for one optimal interaction or a number of optimal interactions.

The computer model can also be further refined to comprise a suitability score for each matching of an agent and a caller. The suitability score can be determined by taking the chances of a set of optimal interactions as predicted by the pattern matching algorithm, and weighting those chances to place more or less emphasis on a particular optimal interaction as related to another optimal interaction. The suitability score can then be used in the present invention to determine which agents should be connected to which callers.

At block 505, connection rules are applied to define when or how to connect agents that are matched to a caller, and the caller is accordingly connected with an agent. The connection rules can be as simple as instructing the present invention to connect a caller according to the best match among all available agents with that particular caller. In this manner, caller hold time can be minimized. The connection rules can also be more involved, such as instructing the present invention to connect a caller only when a minimum threshold match exists between an available agent and a caller, to allow a defined period of time to search for a minimum matching or the best available matching at that time, or to define an order of agent suitability for a particular caller and connect the caller with a currently available agent in that order with the best chances of achieving an optimal interaction. The connection rules can also purposefully keep certain agents available while a search takes place for a potentially better match.

Embodiments of the present invention can also comprise affinity databases, the databases comprising data on an individual caller's contact outcomes (referred to in this application as “caller affinity data”), independent of their demographic, psychographic, or other business-relevant information. Such caller affinity data can include the caller's purchase history, contact time history, or customer satisfaction history. These histories can be general, such as the caller's general history for purchasing products, average contact time with an agent, or average customer satisfaction ratings. These histories can also be agent specific, such as the caller's purchase, contact time, or customer satisfaction history when connected to a particular agent.

The caller affinity data can then be used to refine the matches that can be made using the present invention. As an example, a certain caller may be identified by their caller affinity data as one highly likely to make a purchase, because in the last several instances in which the caller was contacted, the caller elected to purchase a product or service. This purchase history can then be used to appropriately refine matches such that the caller is preferentially matched with an agent deemed suitable for the caller to increase the chances of an optimal interaction. Using this embodiment, a contact center could preferentially match the caller with an agent who does not have a high grade for generating revenue or who would not otherwise be an acceptable match, because the chance of a sale is still likely given the caller's past purchase behavior. This strategy for matching would leave available other agents who could have otherwise been occupied with a contact interaction with the caller. Alternatively, the contact center may instead seek to guarantee that the caller is matched with an agent with a high grade for generating revenue, irrespective of what the matches generated using caller data and agent demographic or psychographic data may indicate.

A more advanced affinity database developed by the present invention is one in which a caller's contact outcomes are tracked across the various agent data. Such an analysis might indicate, for example, that the caller is most likely to be satisfied with a contact if they are matched to an agent of similar gender, race, age, or even with a specific agent. Using this embodiment, the present invention could preferentially match a caller with a specific agent or type of agent that is known from the caller affinity data to have generated an acceptable optimal interaction.

Affinity databases can provide particularly actionable information about a caller when commercial, client, or publicly-available database sources may lack information about the caller. This database development can also be used to further enhance contact routing and agent-to-caller matching even in the event that there is available data on the caller, as it may drive the conclusion that the individual caller's contact outcomes may vary from what the commercial databases might imply. As an example, if the present invention was to rely solely on commercial databases in order to match a caller and agent, it may predict that the caller would be best matched to an agent of the same gender to achieve optimal customer satisfaction. However, by including affinity database information developed from prior interactions with the caller, the present invention might more accurately predict that the caller would be best matched to an agent of the opposite gender to achieve optimal customer satisfaction.

Another aspect of the present invention is that it may develop affinity databases that comprise revenue generation, cost, and customer satisfaction performance data of individual agents as matched with specific caller demographic, psychographic, or other business-relevant characteristics (referred to in this application as “agent affinity data”). An affinity database such as this may, for example, result in the present invention predicting that a specific agent performs best in interactions with callers of a similar age, and less well in interactions with a caller of a significantly older or younger age. Similarly this type of affinity database may result in the present invention predicting that an agent with certain agent affinity data handles callers originating from a particular geography much better than the agent handles callers from other geographies. As another example, the present invention may predict that a particular agent performs well in circumstances in which that agent is connected to an irate caller.

Though affinity databases are preferably used in combination with agent data and caller data that pass through a pattern matching algorithm to generate matches, information stored in affinity databases can also be used independently of agent data and caller data such that the affinity information is the only information used to generate matches.

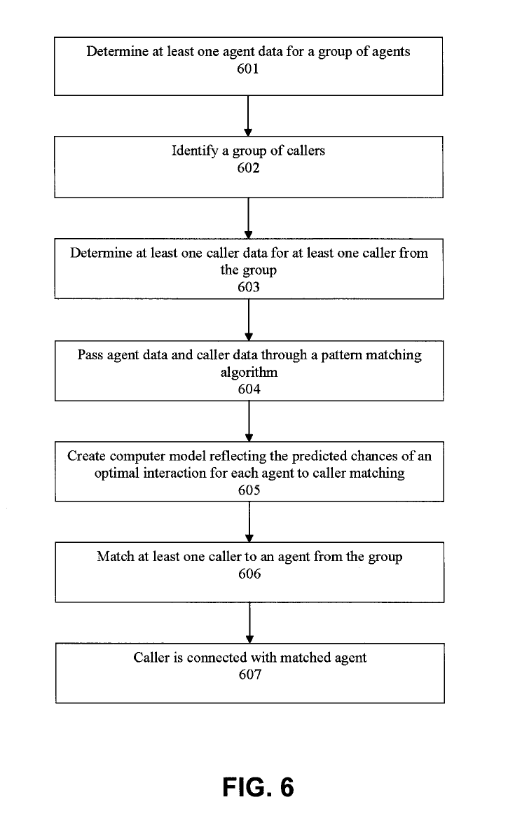

FIG. 6 reflects a method for operating an outbound contact center, the method comprising, determining at least one agent data for each of two agents, identifying a group of at least two callers, determining at least one caller data for at least one caller from the group, using the agent data and the caller data in a pattern matching algorithm; and matching at least one caller from the group to one of the two agents to increase the chance of an optimal interaction. At block 601, at least one agent data is determined for a group of at least two agents. At block 602, a group at least two callers is identified. This is typically accomplished through the use of lead list that is provided to the contact center by the contact center's client. At block 603, at least one caller data for at least one caller from the group is identified.

Once agent data and caller data have been collected, this data is passed to a computational system. The computational system then, in turn, uses this data in a pattern matching algorithm at block 604 to create a computer model that matches each agent with a caller from the group and estimates the probable outcome of each matching along a number of optimal interactions, such as the generation of a sale, the duration of contact, or the likelihood of generating an interaction that a customer finds satisfying. At block 605, the pattern matching algorithm is used to create a computer model reflecting the predicted chances of an optimal interaction for each agent and caller matching.

At block 606, callers are matched with an agent or a group of agents. This matching can be embodied in the form of separate lead lists generated for one or more agents, which the agents can then use to conduct their solicitation efforts. At block 607, the caller is connected to the agent and the agent conducts their solicitation effort. It will be appreciated that the steps outlined in the flowchart of FIG. 6 need not occur in that exact order.

Where a dialer is used to call through a lead list, upon obtaining a live caller, the system can determine the available agents, use caller and agent data with a pattern matching algorithm to match the live caller with one or more of the available agents, and connect the caller with one of those agents. Preferably, the system will match the live caller with a group of agents, define an ordering of agent suitability for the caller within that group, match the live caller to the highest-graded agent that is available in that ordering, and connect the caller to that highest-graded agent. In matching the live caller with a group of agents, the present invention can be used to determine a cluster of agents with similar agent data, such as similar demographic data or psychographic data, and further determine within that cluster an ordering of agent suitability. In this manner, the present invention can increase the efficiency of the dialer and avoid having to stop the dialer until an agent with specific agent data becomes available.

The present invention may store data specific to each routed caller for subsequent analysis. For example, the present invention can store data generated in any computer model, including the chances for an optimal interaction as predicted by the computer model, such as the chances of sales, contact durations, customer satisfaction, or other parameters. Such a store may include actual data for the caller connection that was made, including the agent and caller data, whether a sale occurred, the duration of the contact, the time of the contact, and the level of customer satisfaction. Such a store may also include actual data for the agent to caller matches that were made, as well as how, which, and when matches were considered pursuant to connection rules and prior to connection to a particular agent.

This stored information may be analyzed in several ways. One possible way is to analyze the cumulative effect of the present invention on an optimal interaction over different intervals of time and report that effect to the contact center or the contact center client. For example, the present invention can report back as to the cumulative impact of the present invention in enhancing revenues, reducing costs, increasing customer satisfaction, over five minute, one hour, one month, one year, and other time intervals, such as since the beginning of a particular client solicitation campaign. Similarly, the present invention can analyze the cumulative effect of the present invention in enhancing revenue, reducing costs, and increasing satisfaction over a specified number of callers, for instance 10 callers, 100 callers, 1000 callers, the total number of callers processed, or other total numbers of callers.

One method for reporting the cumulative effect of employing the present invention comprises matching a caller with each agent logged in at the contact center, averaging the chances of an optimal interaction over each agent, determining which agent was connected to the caller, dividing the chance of an optimal interaction for the connected agent by the average chance, and generating a report of the result. In this manner, the effect of the present invention can be reported as the predicted increase associated with routing a caller to a specific agent as opposed to randomly routing the caller to any logged-in agent. This reporting method can also be modified to compare the optimal interaction chance of a specific agent routing against the chances of an optimal interaction as averaged over all available agents or over all logged-in agents since the commencement of a particular campaign. In fact, by dividing the average chance of an optimal interaction over all unavailable agents at a specific period of time by the average chance of an optimal interaction over all available agents at that same time, a report can be generated that indicates the overall boost created by the present invention to the chance of an optimal interaction at that time. Alternatively, the present invention can be monitored, and reports generated, by cycling the present invention on and off for a single agent or group of agents over a period of time, and measuring the actual contact results. In this manner, it can be determined what the actual, measured benefits are created by employing the present invention.

Embodiments of the present invention can include a visual computer interface and printable reports provided to the contact center or their clients to allow them to, in a real-time or a past performance basis, monitor the statistics of agent to caller matches, measure the optimal interactions that are being achieved versus the interactions predicted by the computer model, as well as any other measurements of real time or past performance using the methods described herein. A visual computer interface for changing the weighting on an optimal interaction can also be provided to the contact center or the contact center client, such that they can, as discussed herein, monitor or change the weightings in real time or at a predetermined time in the future.

It is typical for a queue of callers on hold to form at a contact center. When a queue has formed it is desirable to minimize the hold time of each caller in order to increase the chances of obtaining customer satisfaction and decreasing the cost of the contact, which cost can be, not only a function of the contact duration, but also a function of the chance that a caller will drop the contact if the wait is too long. After matching the caller with agents, the connection rules can thus be configured to comprise an algorithm for queue jumping or pooling of callers, whereby a favorable match of a caller on hold and an available agent will result in that caller “jumping” the queue by increasing the caller's connection priority so that the caller is passed to that agent first ahead of others in the chronologically listed queue. The queue jumping or pooling algorithm can be further configured to automatically implement a trade-off between the cost associated with keeping callers on hold against the benefit in terms of the chance of an optimal interaction taking place if the caller is jumped up the queue, and jumping callers up the queue to increase the overall chance of an optimal interaction taking place over time at an acceptable or minimum level of cost or chance of customer satisfaction. Callers can also be jumped up a queue if an affinity database indicates that an optimal interaction is particularly likely if the caller is matched with a specific agent that is already available. Exemplary methods for pooling callers are further described in copending U.S. patent application Ser. No. 12/266,418, titled “POOLING CALLERS FOR MATCHING TO AGENTS BASED ON PATTERN MATCHING ALGORITHMS”, and filed Nov. 6, 2008, which is incorporated herein by reference in its entirety.

Ideally, the connection rules should be configured to avoid situations where matches between a caller in a queue and all logged-in agents are likely to result in a small chance of a sale, but the cost of the contact is long and the chances of customer satisfaction slim because the caller is kept on hold for a long time while the present invention waits for the most optimal agent to become available. By identifying such a caller and jumping the caller up the queue, the contact center can avoid the situation where the overall chances of an optimal interaction (e.g., a sale) are small, but the monetary and satisfaction cost of the contact is high.

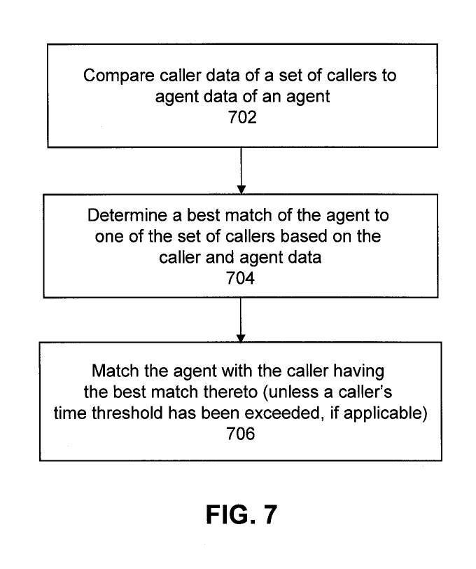

FIG. 7 illustrates a flowchart reflecting an embodiment of the present invention for selecting a caller from a pool of callers using agent data and caller data. The exemplary method include pooling incoming callers and routing callers to agents based on a metric, e.g., a pattern matching suitability score, without relying solely or primarily on the caller's position within a queue. For instance, a caller may be connected with an agent before other callers that have been waiting for a longer period of time based, at least in part, on the pattern matching algorithm. In comparison, a conventional routing system typically includes one or more queues (e.g., based on language, etc.), and may include queue jumping (e.g., based on preferred customers), but are typically set-up to route and connect an available agent with the next caller for an appropriate queue. For instance, with language based routing, callers may be placed into different queues based on appropriate language skills to match the agent, but callers are connected to agents based on order within the queue.

In one example, the method includes comparing caller data of a set of callers to agent data of an available agent at 702. For example, a pattern matching algorithm as described herein may be used with caller data and agent data to determine a best match of an agent with one of a set of callers at 704. The method further includes routing or connecting the agent with the caller having the best match thereto at 706. As additional agents become free the process depicted can be repeated. Additionally, agents may be pooled and routed in a similar fashion, e.g., in an instance with multiple free agents and an incoming caller, the agents may be matched to the caller based on the best match (and not necessarily or primarily based on a queue or idle time of the agents).

In other examples, the amount of waiting time may be included as a factor, e.g., as a weighting factor used with the caller and agent data to determine routing. In other examples, each caller may be assigned a threshold waiting time, which if exceeded, overrides the performance algorithm. Further, each caller may be individually assigned waiting time thresholds, e.g., based on data associated with the caller, or all callers may be given a common waiting time threshold.

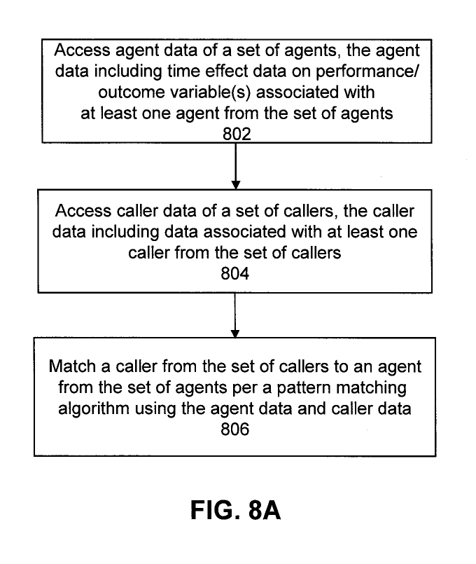

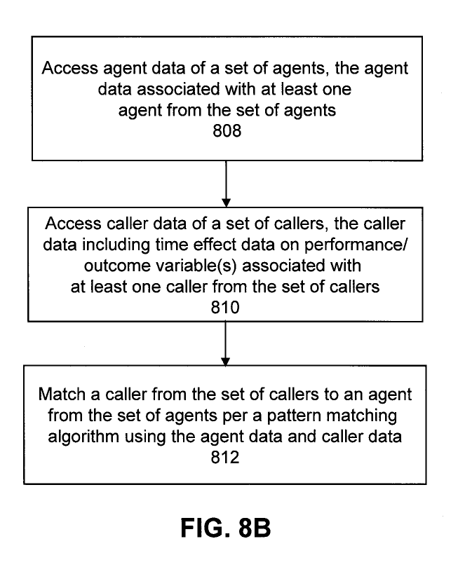

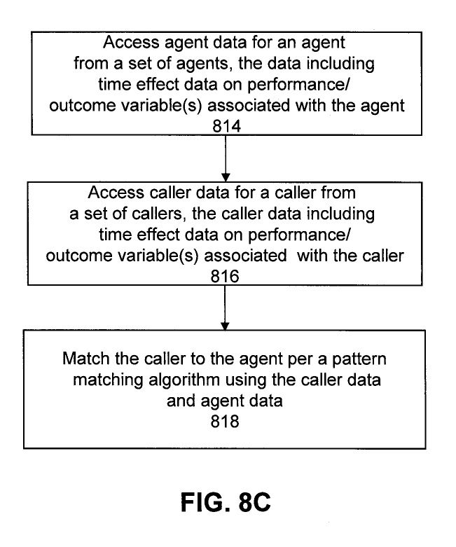

FIG. 8A is a flowchart reflecting an embodiment of the present invention for matching a caller to an agent using time effect data associated with the set of agents. Agent data of a set of agents is retrieved or accessed at 802. In this example, the set of agents includes at least one agent and the agent data includes time effect data associated with at least one agent from the set of agents. The time effect data can be collected and used within the systems and methods alone or in combination with other data, agent grades, and so on for matching agents to incoming callers as described herein. Time effect data may indicate the effect of time to one or more probable outcome variables, where the time may be based on time of the day, week, month, year, season, and so on. For instance, certain agents may perform well in the morning with respect to revenue (or customer satisfaction, cost, etc.), but do not perform well in the afternoon. Further, certain agents may perform well with certain callers at certain times of the day or week, but not with those same caller on other times or days. Additionally, certain callers may react to agents differently depending on the time, e.g., the chance of a sale occurring with a caller over 50 may be substantially greater before 5 pm than after 5 pm. Time effect data may also refer to the duration a particular agent has been employed. For instance, an agent who has only been employed for 2 days may not be as productive as an agent who has been employed for 2 months.

The exemplary method further includes accessing caller data of a set of callers 804. In this example, the set of callers includes at least one caller and the caller data includes data associated with at least one caller from the set of callers. The method further including matching or routing a caller from the set of callers to an agent from the set of agents per a pattern matching algorithm using the agent data and the caller data at 806. According to this embodiment, the caller data may include any information relating to the caller, such as age, race, religion, education, gender, or time effect data. The examples provided are not meant to be an exclusive list, but rather illustrative of the types of data that may be contained within the caller data.

As an example of the present embodiment, the agent data associated with the set of agents may indicate that one agent of the set of agents performs better in the morning than in the afternoon. Thus, a performance based routing and/or pattern matching algorithm may determine that pairing a caller with the particular well performing agent, based on time etc., will have a relatively high probability of resulting in a positive interaction. Accordingly, the performance based routing and/or pattern matching algorithm may then route the caller to the agent. It will be appreciated that the steps outlined in the flowchart of FIG. 8A need not occur in that exact order.

FIG. 8B is a flowchart reflecting an embodiment of the present invention for matching a caller to an agent using time effect data associated with at least the caller. Agent data of a set of agents is retrieved or accessed at 808, wherein the set of agents includes at least one agent and wherein the agent data includes data associated with at least one agent from the set of agents. The method further including accessing caller data of a set of callers at 810. In this example, the set of callers includes at least one caller and the caller data includes time effect data associated with at least one caller from the set of callers. The method further comprising matching or routing a caller from the set of callers to an agent from the set of agents per a pattern matching algorithm using the agent data and the caller data at 812. It will be appreciated that the steps outlined in the flowchart of FIG. 8B need not occur in that exact order.

FIG. 8C is a flowchart reflecting another embodiment of the present invention for matching a caller to an agent using time effect data associated with both the set of callers and agents. Agent data associated with an agent from a set of agents is retrieved or accessed at 814, where in this example agent data includes time effect data associated with at least one agent from the set of agents. Further, the set of agents may contain at least one agent. The method further including accessing caller data associated with a caller from a set of callers at 816, where in this example caller data includes a time effect data associated with at least one caller of the set of callers. Further, the set of callers may contain at least one caller. The method further including matching or routing the caller to the agent per a pattern matching algorithm using the agent data and the caller data at 818. It will be appreciated that the steps outlined in the flowchart of FIG. 8C need not occur in that exact order.

Many of the techniques described here may be implemented in hardware, firmware, software, or combinations thereof. Preferably, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices. Moreover, each program is preferably implemented in a high level procedural or object-oriented programming language to communicate with a computer system. However, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

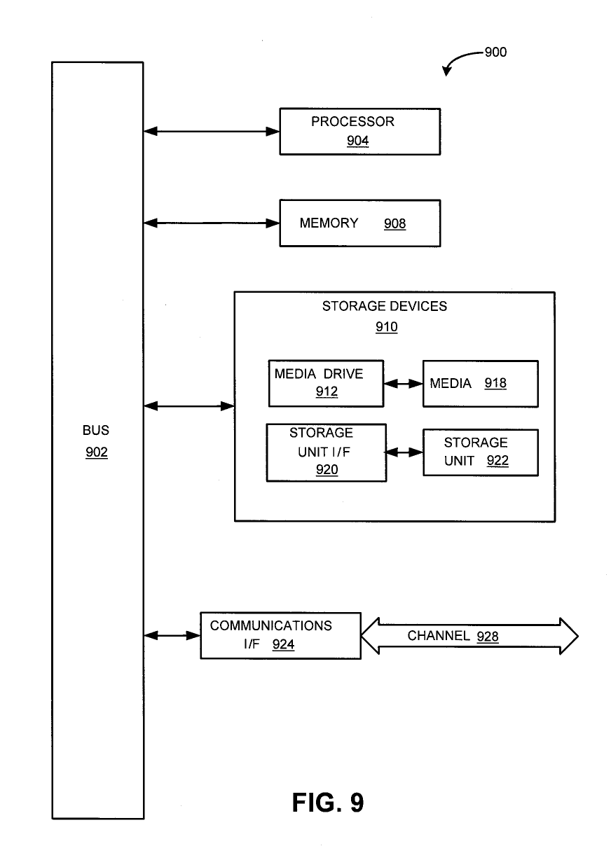

FIG. 9 illustrates a typical computing system 900 that may be employed to implement processing functionality in embodiments of the invention. Computing systems of this type may be used in clients and servers, for example. Those skilled in the relevant art will also recognize how to implement the invention using other computer systems or architectures. Computing system 900 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 900 can include one or more processors, such as a processor 904. Processor 904 can be implemented using a general or special purpose processing engine such as, for example, a microprocessor, microcontroller or other control logic. In this example, processor 904 is connected to a bus 902 or other communication medium.

Computing system 900 can also include a main memory 908, such as random access memory (RAM) or other dynamic memory, for storing information and instructions to be executed by processor 904. Main memory 908 also may be used for storing temporary variables or other intermediate information during execution of instructions to be executed by processor 904. Computing system 900 may likewise include a read only memory (“ROM”) or other static storage device coupled to bus 902 for storing static information and instructions for processor 904.

The computing system 900 may also include information storage system 910, which may include, for example, a media drive 912 and a removable storage interface 920. The media drive 912 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 918 may include, for example, a hard disk, floppy disk, magnetic tape, optical disk, CD or DVD, or other fixed or removable medium that is read by and written to by media drive 912. As these examples illustrate, the storage media 918 may include a computer-readable storage medium having stored therein particular computer software or data.

In alternative embodiments, information storage system 910 may include other similar components for allowing computer programs or other instructions or data to be loaded into computing system 900. Such components may include, for example, a removable storage unit 922 and an interface 920, such as a program cartridge and cartridge interface, a removable memory (for example, a flash memory or other removable memory module) and memory slot, and other removable storage units 922 and interfaces 920 that allow software and data to be transferred from the removable storage unit 918 to computing system 900.

Computing system 900 can also include a communications interface 924. Communications interface 924 can be used to allow software and data to be transferred between computing system 900 and external devices. Examples of communications interface 924 can include a modem, a network interface (such as an Ethernet or other NIC card), a communications port (such as for example, a USB port), a PCMCIA slot and card, etc. Software and data transferred via communications interface 924 are in the form of signals which can be electronic, electromagnetic, optical or other signals capable of being received by communications interface 924. These signals are provided to communications interface 924 via a channel 928. This channel 928 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable storage medium” and the like may be used generally to refer to physical, tangible media such as, for example, memory 908, storage media 918, or storage unit 922. These and other forms of computer-readable storage media may be involved in storing one or more instructions for use by processor 904, to cause the processor to perform specified operations. Such instructions, generally referred to as “computer program code” (which may be grouped in the form of computer programs or other groupings), when executed, enable the computing system 900 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable storage medium and loaded into computing system 900 using, for example, removable storage media 918, drive 912, or communications interface 924. The control logic (in this example, software instructions or computer program code), when executed by the processor 904, causes the processor 904 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

The above-described embodiments of the present invention are merely meant to be illustrative and not limiting. Various changes and modifications may be made without departing from the invention in its broader aspects. The appended claims encompass such changes and modifications within the spirit and scope of the invention.

We claim:

1. A method for operating a call routing center, the method comprising:
grading at least two agents from a set of agents on an optimal interaction, wherein the grading is associated with a time; and
matching a caller from a set of callers to an agent from a set of agents based on the grading of the set of agents and the time.

2. The method of claim 1, further comprising routing the caller to one of the set of agents based on the grading and the time.

3. The method of claim 1, wherein the time relates to one or more of the following: a time of day, day of week, time of month, and time of year.

4. The method of claim 1, wherein the time relates to a duration of employment of the agent.

5. The method of claim 1, wherein the time relates to a non-stationary time effect of performance of one or more of the set of agents.

6. A method for operating a call routing center, the method comprising:
matching a caller from a set of callers to an agent from a set of agents based on a pattern matching algorithm utilizing the following:
agent data associated with the agent from the set of agents; and
caller data associated with the caller from the set of callers,
wherein one or both of the agent data and the caller data is associated with time effect data.

7. The method of claim 6, wherein the set of callers comprises at least one caller and the set of agents comprises at least one agent.

8. The method of claim 6, wherein the time effect data relates to one or more of the following: a time of day, day of week, time of month, and time of year.

9. The method of claim 6, wherein the time effect data is associated with agent performance.

10. The method of claim 6, wherein the time effect data relates to a duration of employment of the agent.

11. The method of claim 6, wherein the time effect data relates to a non-stationary effect of performance of one or more of the set of agents or set of callers.

12. The method of claim 6, wherein the caller is not routed based on a queue order.

13. The method of claim 6, where the caller is not routed based solely on a queue order.

14. A computer readable storage medium comprising program code for operating a call routing center, the computer readable storage medium comprising program code for:
grading at least two agents from a set of agents on an optimal interaction, wherein the grading is associated with a time; and
matching a caller from a set of callers to an agent from a set of agents based on the grading of the set of agents and the time.

15. The computer readable storage medium of claim 14, further comprising program code for routing the caller to one of the set of agents based on the grading and the time.

16. The computer readable storage medium of claim 14, wherein the time relates to one or more of the following: a time of day, day of week, time of month, and time of year.

17. The computer readable storage medium of claim 14, wherein the time relates to a duration of employment of the agent.

18. A computer readable storage medium comprising program code for operating a call routing center, the computer readable storage medium comprising program code for:
routing a caller from a set of callers to an agent from a set of agents based on a pattern matching algorithm utilizing the following:
agent data associated with the agent from the set of agents; and
caller data associated with the caller from the set of callers,
wherein one or both of the agent data and the caller data is associated with time effect data.

19. The computer readable storage medium of claim 18, wherein the set of callers comprises at least one caller and the set of agents comprises at least one agent.

20. The computer readable storage medium of claim 18, wherein the time effect data relates to one or more of the following: a time of day, day of week, time of month, and time of year.

21. The computer readable storage medium of claim 18, wherein the time effect data is associated with agent performance.

22. The computer readable storage medium of claim 18, wherein the time effect data relates to a duration of employment of the agent.

23. The computer readable storage medium of claim 18, wherein the caller is not routed based on a queue order.

24. The computer readable storage medium of claim 18, wherein the caller is not routed based solely on a queue order.

25. Apparatus for operating a call routing center, comprising:
time routing logic for routing a caller from a set of callers to an agent from a set of agents based on a pattern matching algorithm utilizing:
agent data associated with the agent from the set of agents; and
caller data associated with the caller from the set of callers,
wherein one or both of the agent data and the caller data is associated with time effect data.

26. The apparatus of claim 25, wherein the set of callers comprises at least one caller and the set of agents comprises at least one agent.

27. The apparatus of claim 25, wherein the time effect data relates to one or more of the following: a time of day, day of week, time of month, and time of year.

28. The apparatus of claim 25, wherein the time effect data relates to agent performance.

29. The apparatus of claim 25, wherein the time effect data relates to a duration of employment of the agent.

30. The apparatus of claim 25, wherein the caller is not routed based on a queue order.

31. The apparatus of claim 25, where the caller is not routed based solely on a queue order.
